(19) United States
(12) Patent Application Publication
(10) Pub. No.: US 2008/0293014 A1
(43) Pub. Date: Nov. 27, 2008

(54) EMERGENCY IMPLANT FIXTURE

(76) Inventor: Sung-Min CHUNG, SEOUL (KR)

Correspondence Address: IPLA P.A., 3580 WILSHIRE BLVD., 17TH FLOOR, LOS ANGELES, CA, 90010, US

(21) Appl. No.: 12/126,669

(22) Filed: May 23, 2008

(30) Foreign Application Priority Data
May 23, 2007 (KR) 10-2007-0050457

(51) Int. Cl. A61C 8/00

(52) U.S. Cl. 433/174

(57) ABSTRACT

Disclosed is an emergency implant fixture comprises a body having tapered outside in which its diameter is decreased from its upper portion to its lower portion, external screw threads formed on the tapered outside of the body, and internal screw threads formed in the body to be extended from an inserting recess formed in a center of the upper portion of the body. The fixture is directly planted into a damaged alveolar bone without supplementing any substitute materials.

### CROSS REFERENCES

This application claims the priority under Paris Convention of Korean Patent Application No. 10-2007-0050457 filed May 23, 2007.

### BACKGROUND OF THE INVENTION

1. Field of the Invention

The present invention relates to a fixture used in an emergent implant surgical operation after failure of a general implant surgical operation, and more particularly, to an emergency implant fixture enabling to broaden contacting area required in plant by differing upper and lower portions thereof in diameter and to block an occurrence of excessive torque.

2. Description of the Related Art

In general, implant means a substitute for recovering lost tissues of the human, but in dental field, it means transplantation of artificial teeth. The implant is used in recovering function of teeth by planting a dental root made of titanium etc. which does not raise rejection symptoms in the human body onto snag and by fixing an artificial tooth onto the dental root so as to be able to substitute a dental root of lost tooth.

The implant has a good advantage in which it does not damage neighboring teeth tissues and can be permanently used since it has similarity with natural teeth in function and in shape and does not raise decay of teeth whereas general prosthesis for teeth or artificial teeth has a problem in which it gives damage to neighboring teeth or bones.

To complete implant artificial teeth by planting a fixture of the above implant onto an alveolar bone, the fixture is osseointegrated to be fixed onto a bone like a root of a natural tooth, and then an abutment is connected to the osseointegrated fixture using an abutment screw, and finally an artificial crown is mounted onto the abutment. At this time, the implant passes through a compact bone having relatively higher bone density and planted into a trabecular bone having relatively lower bone density.

On occurring failure of a surgical operation using the fixture, an emergent implant surgical operation is done to operate an implant surgical operation. At this time, a fixture used in the emergent implant surgical operation generally has the same diameter at its upper and lower portions.

The fixture used in the emergent implant surgical operation has relatively large diameter than a general fixture used in implant surgical operation, and therefore occurrence of an excessive torque, a destruction of around tissues and a movement after operation is done, which should be solved.

### SUMMARY OF THE INVENTION

The present invention has been made to solve the above-mentioned conventional problems, and accordingly it is the object of the present invention to provide an emergency implant fixture having a broadened contacting area between a compact bone and the fixture, an enhanced close adhesion between an alveolar bone and the fixture and smaller torque in planting by tapering body of the fixture.

In order to achieve the object of the present invention, the present invention provides an emergency implant fixture comprising: a body having tapered outside in which its diameter is decreased from its upper portion to its lower portion; external screw threads formed on the tapered outside of the body; and internal screw threads formed in the body to be extended from an inserting recess formed in a center of the upper portion of the body, wherein the fixture is directly planted into a damaged alveolar bone without supplementing any substitute materials.

In the emergency implant fixture, if the diameters of the upper and lower portions of the body are D and d respectively, the diameter d of the lower portion is 0.7 D (d=0.7 D).

In the emergency implant fixture, the external screw threads formed on the body is single-typed screw threads or double-typed screw threads in order to be planted with its minimum rotation during plantation onto the alveolar bone.

### BRIEF DESCRIPTION OF THE DRAWING

The above and other objects and advantages of the present invention will become readily apparent by reference to the following detailed description when considered in conjunction with the accompanying drawing wherein:

FIG. 1 is a perspective view schematically illustrating according to one preferred embodiment of the present invention;

FIG. 2 is a perspective view schematically illustrating according to another preferred embodiment of the present invention;

FIG. 3 is a sectional view schematically illustrating the fixture in FIG. 1 or 2;

FIG. 4 is a bottom view schematically illustrating the fixture in FIG. 1 or 2; and

FIG. 5 is an exemplary view to use the fixture in FIG. 1 or 2.

### DETAILED DESCRIPTION OF THE PREFERRED EMBODIMENT

Hereinafter, an emergency implant fixture according to the preferred embodiments of the present invention will be described in detail with reference to the accompanying drawings.

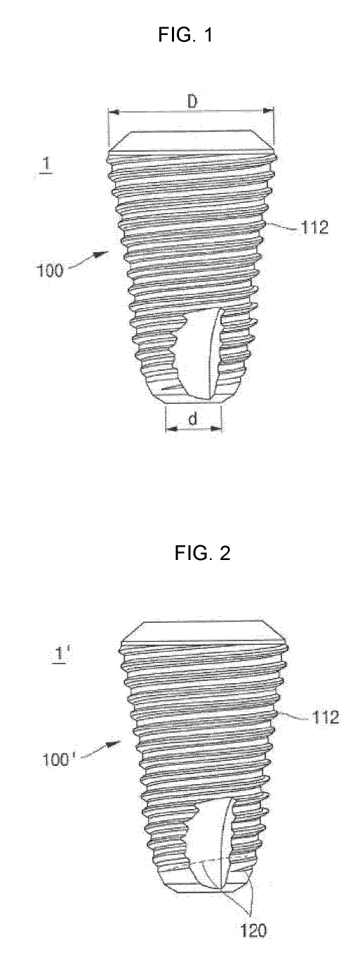

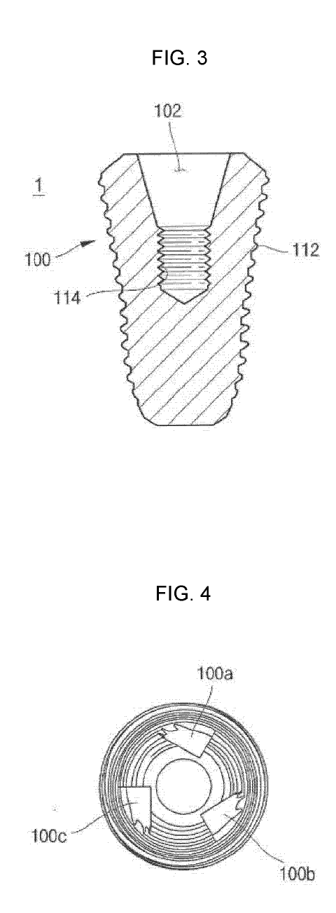

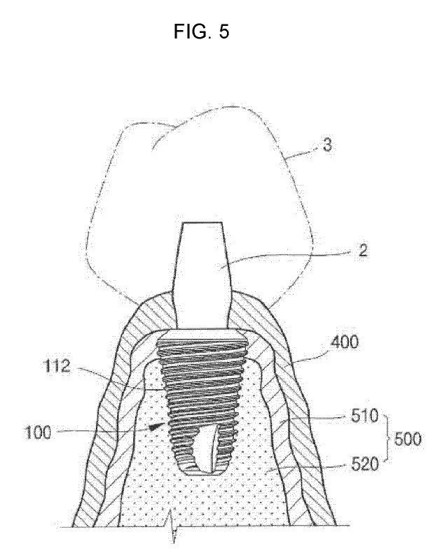

FIG. 1 is a perspective view schematically illustrating according to one preferred embodiment of the present invention, FIG. 2 is a perspective view schematically illustrating according to another preferred embodiment of the present invention, FIG. 3 is a sectional view schematically illustrating the fixture in FIG. 1 or 2, FIG. 4 is a bottom view schematically illustrating the fixture in FIG. 1 or 2, and FIG. 5 is an exemplary view to use the fixture in FIG. 1 or 2.

As shown in FIGS. 1 to 5, fixtures 1 and 1′ are directly planted into a damaged alveolar bone 510 without supplementing any substitute materials. The fixtures 1 and 1′ comprise bodies 100 and 100′ having tapered outsides in which their diameters are decreased from an upper portion to a lower portion thereof. External screw threads 112 are formed on the tapered outsides of the bodies 100 and 100′, and internal screw threads 114 are formed in the bodies 100 and 100′ to be extended from an inserting recess 102 formed in the center of the upper portion of the bodies 100 and 100′.

On assuming the diameters of the upper and lower portion of the bodies 100 and 100′ as D and d, respectively, the diameter “d” of the lower portion of the bodies 100 and 100′ is preferably “0.7 D”.

External screw threads 112 formed on the body 100 are single-typed screw threads, whereas external screw threads 112 formed on the body 100′ are double-typed screw threads in order to be planted with minimum rotation thereof during plantation onto an alveolar bone.

Three self-tapping recesses 100a, 100b and 100c are formed on the outer periphery surface of the lower portion of the bodies 100 and 100′ of the fixtures 1 and 1′ according to the present invention. The self-tapping recesses 100a, 100b and 100c serve to self-tap when the fixtures 1 and 1′ are planted into the alveolar bone 500, and they are preferably symmetrically arranged in triangle on the periphery surface of the bodies 100 and 100′.

Installation of the emergency implant fixture having above-mentioned structure according to the present invention is described with reference to the accompanying drawings.

As shown in FIGS. 1 to 5, fixtures 1 and 1′ according to the present invention have the upper portion with relatively large diameter “D” and the lower portion with relatively small diameter “d” in order to be directly planted into the damaged alveolar bone 510 without supplementing any substitute materials on occurring failure of surgical operation using general used implant.

The diameter of firstly operated fixture (not shown) and the diameter of the fixtures 1 and 1′ are different from each other, and therefore a position to be planted with the fixtures 1 and 1′ should be formed with holes by a desired tool such as a drill prior to plantation in order to operate the fixtures 1 or 1′ to a patient. Forming holes is performed to allow the fixtures 1 or 1′ to be well planted and to prevent the fixtures 1 or 1′ from occurring excessive torque which may be occurred during plantation.

After forming holes, the inserting recess 102 formed in the fixtures 1 or 1′ is connected to an end portion of a hand-piece connector (not shown), and then the fixtures 1 or 1′ is planted into the alveolar bone at a condition in which the fixtures 1 or 1′ is connected to the hand-piece connector.

The alveolar bone is comprised of the compact bone 510 which is a portion of the gum(s) 400 and the trabecular bone 520 which is below the gum and relatively soft than the compact bone 510. The fixture 1 is planted into a hole formed on the gum(s) 400 and the compact bone 510 by placing the lower portion of the fixture 1 on the hole and by rotating the fixture 1.

At this time, the external screw threads 112 formed on the outside of the body 100 of the fixture 1 is engaged with the compact bone 510, and then it is inserted into the trabecular bone 520, and finally it is reliably engaged with and planted into the compact bone 510.

At this time, the fixture 1 and the compact bone 510 are engaged from each other having enhanced fixing ability since the contacting area between the compact bone 510 and the body 110 of the fixture 1 is broaden by virtue of the tapered body 110.

The external screw thread 120 formed on the fixtures 1 or 1′ according to the present invention is preferably formed in single-typed thread or in double-type thread. The double-type thread allows the working time required in plantation to be decreased and allows fast implant surgical operation since the number of rotation required in connection may be minimized.

Further, the ratio between the diameters d and D of the lower and upper portions of the body 100 of the fixture 1 is preferably to be 1:1.3. This broadens a contacting area between the compact bone 510 and the body 110 of the fixture 1, enhances an adhesive ability for the compact bone 510, and continually stimulates the compact bone 510, and therefore the conventional problem in which the fixture 1 is moved after operation can be solved and an effect in which bones are merged can be expected.

The emergency implant fixture according to the present invention is reliably planted with several rotations under implant surgical operation, and thereby an occurrence of excessive torque, an enhanced contacting adherence between a compact bone and the fixture, and an enhanced contacting adherence between an alveolar bone and the fixture are performed.

Although the preferred embodiment of the present invention have been described, it is understood that the present invention should not be limited to these preferred embodiments but various changes and modifications can be made by one skilled in the art within the sprit and scope of the present invention aimed.

What is claimed is:

1. An emergency implant fixture, the fixture comprising:
a body having tapered outside in which its diameter is decreased from its upper portion to its lower portion;
external screw threads formed on the tapered outside of the body; and
internal screw threads formed in the body to be extended from an inserting recess formed in a center of the upper portion of the body, wherein
the fixture is directly planted into a damaged alveolar bone without supplementing any substitute materials.

2. The emergency implant fixture according to claim 1, wherein if the diameters of the upper and lower portions of the body are D and d respectively, the diameter d of the lower portion is 0.7 D (d=0.7 D).

3. The emergency implant fixture according to claim 1, wherein the external screw threads formed on the body is single-typed screw threads or double-typed screw threads in order to be planted with its minimum rotation during plantation onto the alveolar bone.
